(19) United States
(12) Patent Application Publication
(10) Pub. No.: US 2020/0377198 A1
(43) Pub. Date: Dec. 3, 2020

(54) SYSTEM FOR RE-ENERGIZING STREAMFLOW IN CONTROL SURFACES OF AIRCRAFT

(71) Applicant: Airbus Operations, S.L., Getafe (ES)

(72) Inventors: Alfonso PARRA RUBIO, Getafe (ES); Alvaro JARA RODELGO, Getafe (ES)

(21) Appl. No.: 16/886,383

(22) Filed: May 28, 2020

(30) Foreign Application Priority Data
May 31, 2019 (EP) 19382448.9

(51) Int. Cl. B64C 23/06

(52) U.S. Cl. CPC B64C 23/06; F15D 1/12

(57) ABSTRACT

A system for re-energizing streamflow in control surfaces of aircraft, comprising a panel provided with at least one aerodynamic element movable at least between a rest position, where the at least one aerodynamic element does not protrude from the panel, and a use position, where the at least one aerodynamic element protrudes from the panel, acting as a vortex generator. The at least one aerodynamic element is a die-cut portion of the panel that is hinged to a remainder of the panel.

### CROSS-REFERENCES TO RELATED APPLICATIONS

This application claims the benefit of the European patent application No. 19382448.9 filed on May 31, 2019, the entire disclosures of which are incorporated herein by way of reference.

### FIELD OF THE INVENTION

The present invention refers to a system able to hide and unhide aerodynamic elements for re-energizing streamflow in control surfaces of aircraft. The main feature of the present invention is that the surface when bent, will create an edge shape which will act as a vortex generator.

### BACKGROUND OF THE INVENTION

In aircraft, aerodynamic elements are used to re-energize streamflow in their control surfaces. These aerodynamic elements create an edge shape that acts as a vortex generator.

These aerodynamic elements that act as vortex generators can be divided in two types: fixed systems and hide/unhide systems.

The fixed systems used to re-energize the streamflow consist on the generation of a small quantity of lift with a small flat aerodynamic element aligned with the streamlines, but with a very low angle of attack that generates a high energy vortex. This energy vortex is able to follow the control surface, increasing the efficiency of it.

These aerodynamic elements are permanent, so they create a benefit when re-energization is needed, increasing the efficiency of an empennage, for example, up to 16% more, but also, when they are not needed, they generate a drag penalty, for example, in cruise conditions.

The hide/unhide systems are active systems able to show the aerodynamic elements only when they are needed. The main advantage is that they avoid creating a penalty in drag in cruise condition but, on the other hand, this system requires maintenance, which creates a conflict with airlines, occupy volume in a critical zone and they used to be very complex.

The location of the aerodynamic elements is between a fixed part and the movable part (control surfaces). Due to the actual state of the art of manufacturing processes, this transition zone used to be rigid in the actual state of the art.

Therefore, one purpose of the present invention is to provide a system for re-energizing streamflow that combines the advantages of the fixed and hide/unhide systems, providing a passive hide/unhide system.

### SUMMARY OF THE INVENTION

With the system according to the present invention it is possible to solve these drawbacks, providing other advantages that are described below.

The system for re-energizing streamflow in control surfaces of aircraft according to the present invention comprises a panel provided with at least one aerodynamic element movable at least between a rest position, where the at least one aerodynamic element does not protrude from the panel, and a use position, where the at least one aerodynamic element protrude from the panel, acting as a vortex generator,

wherein the at least one aerodynamic element is a die-cut portion of the panel, that is hinged to the rest of the panel.

Furthermore, the panel is flexible, so that the panel can be curved during some phases of use of the aircraft.

Advantageously, in the use position, the aerodynamic element defines a deflection angle with respect to the panel, the deflection angle being variable.

According to a preferred embodiment, the aerodynamic element comprises a fixed end joined to the panel, the fixed end defining a control line, and a movable end.

According to the preferred embodiment, the movable end has a pointed shape, such as, for example, an arrow shape, even though it can be of any suitable shape.

In the embodiment, the fixed end can be divided in a plurality of sections, and the aerodynamic element can comprise at least one longitudinal slot. The longitudinal slot(s) can be defined by the sections in which the fixed end is divided.

The value of the present invention resides in the way that the aerodynamic elements that generate lift are activated.

These aerodynamic elements are placed in a zone where one or more curvatures will be generated, and this curvature is the one which generates shapes which will behave as vortex generators.

The main advantage of the present invention is that it is a passive system able to hide and unhide the aerodynamic elements in order to be used only when it is necessary, so the penalty at cruise conditions is avoided.

The main advantage versus systems that hides and unhide the aerodynamic elements is that this system is passive, i.e., it does not require any maintenance and it does not occupy space in the zone between the torsion box and the control surface, a zone which used to be very crowded.

### BRIEF DESCRIPTION OF THE DRAWINGS

For a better understanding the above explanation and for the sole purpose of providing an example, some non-limiting drawings are included that schematically depict a practical embodiment.

FIG. 1 is a perspective of a portion of a wing of an aircraft, showing an aerodynamic element of the system according to the present invention placed between a control surface and a torsion box;

FIG. 2 is a perspective view of an aerodynamic element of the system according to the present in its rest position;

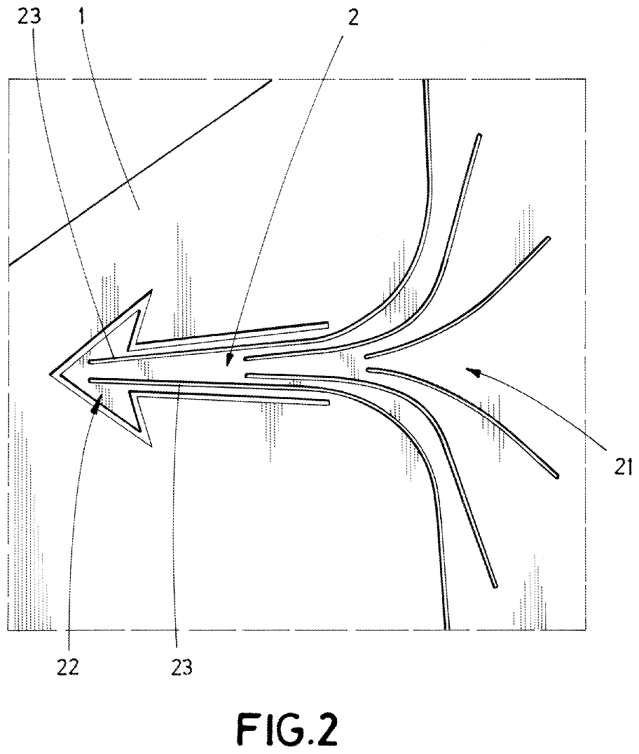

FIG. 3 is a perspective view of the aerodynamic element shown in FIG. 2 in its use position; and

FIGS. 4-6 are perspective view showing different positions of an aerodynamic element of the system according to the present invention.

### DETAILED DESCRIPTION OF THE PREFERRED EMBODIMENTS

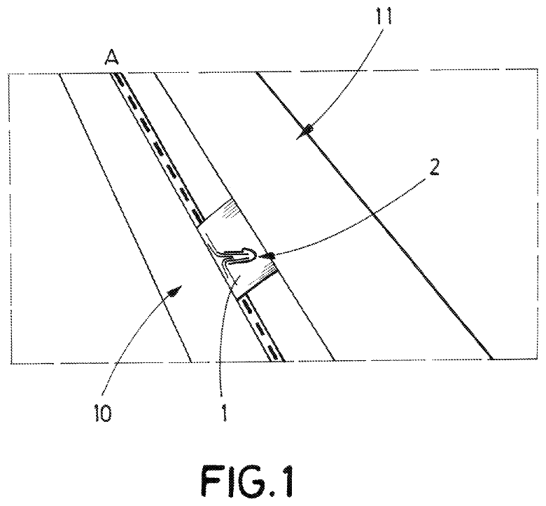

As shown in FIG. 1, the system according to the present invention is preferably used in a wing of an aircraft, in particular, in a zone between a control surface 10 and a torsion box 11, where a panel 1 is placed.

The panel 1 is made from a flexible material than can be curved during some phases of use of the aircraft and the panel 1 comprises at least one aerodynamic element 2, which can be placed passively, i.e., automatically, in its use position acting as a vortex generator or in its rest position, as will be described hereinafter.

The aerodynamic element 2 is a die-cut portion of the flexible panel 1, which is hinged to the rest of the panel 1, defining a fixed end 21 and a movable end 22.

The fixed end 21 defines a control line A, shown in FIG. 1, as a hinge axis, and the movable end 22 can be moved between the use and rest positions, defining a deflection angle α with respect to the flexible panel 1.

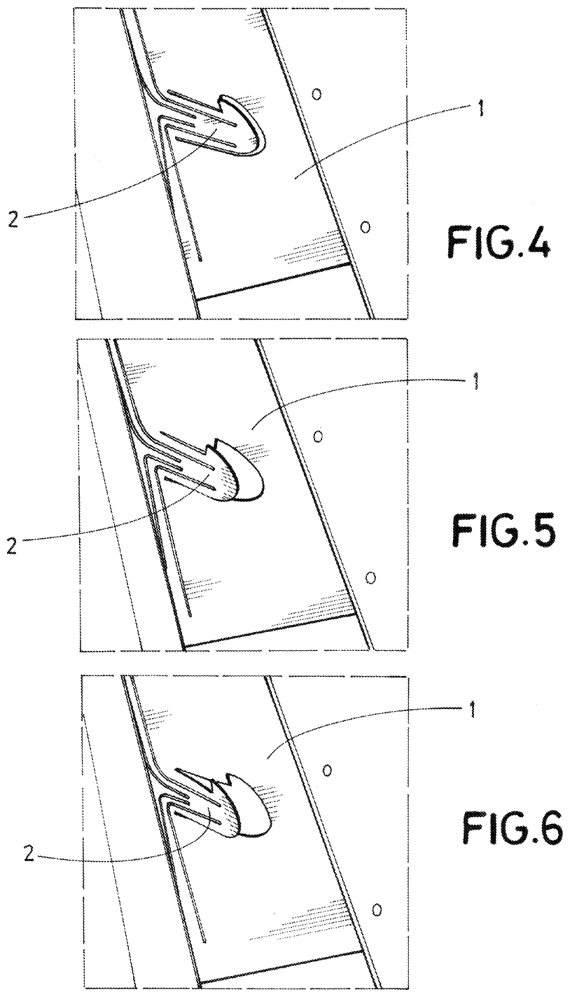

As shown particularly in FIGS. 4-6, the deflection angle α is variable depending on the use conditions.

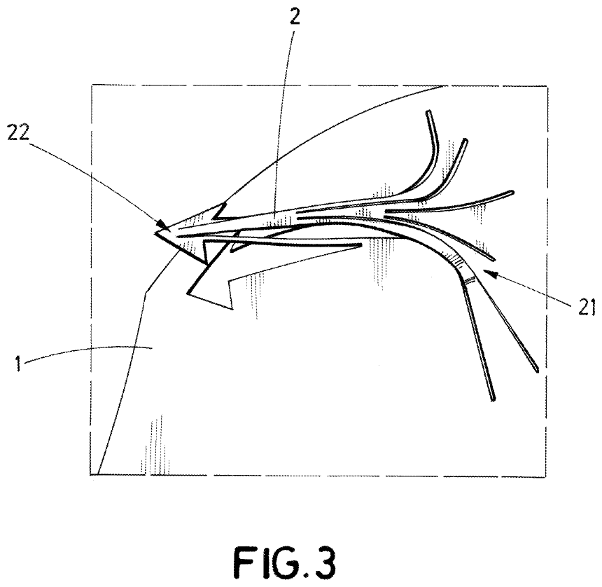

The aerodynamic element 2 can also comprise at least one longitudinal slot 23, as shown particularly in FIG. 3, and its fixed end 21 can be divided in a plurality of sections, from which the longitudinal slot(s) 23 can be defined.

As shown in the Figures, the movable end 22 of the aerodynamic element 2 has preferably a pointed shaped, such as, e.g., an arrow shape, even though the movable end 22 can be made of any suitable shape.

The operation of the re-energizing streamflow system according to the present invention is very simple.

In certain conditions of the aircraft, e.g., in cruise conditions, the aerodynamic element(s) 2 is(are) in the rest position, i.e., hidden, not protruding from the panel 1.

In other conditions of the aircraft where the vortex generators are necessary, the aerodynamic element(s) is(are) in the use position, i.e., unhidden or protruding from the panel 1.

This change of position is made in a passive way, i.e., automatically due to the flexibility of the panel 1 and of the aerodynamic element(s) 2.

Therefore, as stated previously the system permits to hide and unhide the aerodynamic element(s) 2 in order to be used only when it is necessary, so the penalty at cruise conditions is avoided.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A system for re-energizing streamflow in control surfaces of aircraft, comprising:
a panel provided with at least one aerodynamic element movable at least between a rest position, where the at least one aerodynamic element does not protrude from the panel, and a use position, where the at least one aerodynamic element protrudes from the panel, acting as a vortex generator,
wherein said at least one aerodynamic element is a die-cut portion of said panel that is hinged to a remainder of said panel.

2. The system for re-energizing streamflow in control surfaces of aircraft according to claim 1, wherein in the use position, the aerodynamic element defines a deflection angle with respect to the panel.

3. The system for re-energizing streamflow in control surfaces of aircraft according to claim 2, wherein said deflection angle is variable.

4. The system for re-energizing streamflow in control surfaces of aircraft according to claim 1, wherein the aerodynamic element comprises a fixed end joined to the panel, said fixed end defining a control line, and a movable end.

5. The system for re-energizing streamflow in control surfaces of aircraft according to claim 4, wherein the movable end has a pointed shape.

6. The system for re-energizing streamflow in control surfaces of aircraft according to claim 4, wherein the fixed end is divided in a plurality of sections.

7. The system for re-energizing streamflow in control surfaces of aircraft according to claim 1, wherein the aerodynamic element comprises at least one longitudinal slot.
